(19) United States
(12) Patent Application Publication
(10) Pub. No.: US 2009/0257029 A1
(43) Pub. Date: Oct. 15, 2009

(54) IMAGE FORMING DEVICE

(76) Inventors: Tetsuro Mizushima, Osaka (JP); Kazuhisa Yamamoto, Osaka (JP); Yoshimasa Fushimi, Osaka (JP); Kiminori Mizuuchi, Osaka (JP); Shin-ichi Kadowaki, Hyogo (JP); Tatsuo Itoh, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/066,345

(22) PCT Filed: Sep. 1, 2006
(86) PCT No.: PCT/JP2006/317354

§ 371 Date: Mar. 10, 2008

(30) Foreign Application Priority Data
Sep. 14, 2005 (JP) 2005-266526

(51) Int. Cl. G03B 21/14; G02B 27/48

(52) U.S. Cl. 353/30

(57) ABSTRACT

An image forming device which has a high reliability and forms an image without speckle noise is provided.

The image forming device has a light source unit that emits laser beams by a plurality of laser beam outputting sections, and a modulation element that is irradiated with the laser beams emitted from the plurality of laser beam outputting sections. At least one laser beam outputting section emits the laser beam at a different timing from the other laser beam outputting sections, and a beam angle of at least one laser beam outputting section which irradiates the modulation element is different from a beam angle of the other laser beam outputting sections which irradiate the modulation element.

### TECHNICAL FIELD

The present invention relates to an image forming device such as a television receiver and a video projector.

### BACKGROUND ART

As an image forming device, a projection display which projects a picture image on a screen has become widely used. For the projection display, in general, a lamp light source is used. However, the lamp light source has problems of short life, restricted color reproducing area, and low light use efficiency.

In order to solve these problems, attempts have been made to use a laser light source as a light source of the image forming device. Because the laser light source has longer life and stronger directivity than the lamp light source, the laser light source is able to easily improve the light use efficiency. In addition, since the laser light source shows monochromaticity, it has a large color reproducing area and can display vivid images.

However, in a display using the laser light source, laser beam coherency is high and speckle noise is generated.

The speckle noise is microscopic granular noise which is generated by interference of scattered light when laser beams are scattered on a screen and is visible by observers' eyes. The speckle noise becomes a noise such that grains are randomly arranged, the size of grain being determined by the F (F-number) of observers' eyes and laser beam wavelength. The speckle noise obstructs observers from catching screen images and gives rise to serious image deterioration.

In addition, in the speckle noise, there is a noise of the diffracting plane (lighting), which is projected on the screen. This speckle noise causes unevenness of images and deteriorates images.

A large number of methods to reduce the speckle noise have been proposed to date. A display device according to patent document 1 irradiates a modulation element by moving diffusion elements. By allowing diffusion elements to make a movement, speckle patterns generated by the diffusion elements are varied in terms of time and the illumination light angle of the modulation element is materially varied. As a result, since the angle at which the screen is projected is varied in terms of time, speckle patterns generated in the screen are varied. Because a viewer recognizes a plurality of speckle patterns, the speckle noise distribution is averaged and speckle noises are reduced.

A laser image system according to patent document 2 multi-arrays a laser light source and expands the spectral width of the total output from the array. As a result, interference is lowered and speckle noise is reduced.

Patent document 1: JP-A-6-208089

Patent document 2: JP-A-2004-503923

### DISCLOSURE OF INVENTION

### Problem to be Solved by the Invention

In order to move the diffusion element in the case of patent document 1, a movable component which is a physical movement mechanism must be installed. However, deterioration of the movable component causes problems in reliability as the display device.

Only expanding the spectral width in the case of patent document 2 cannot remove the speckle noise of light projected on the screen.

It is the objective of the present invention to solve the above-mentioned conventional problems and to provide an image forming device that has high reliability and forms an image from which speckle noise is removed.

### Means for Solving Problem

An image forming device according to the present invention has a light source unit that emits laser beams by a plurality of laser beam outputting sections, and a modulation element that is irradiated with the laser beams emitted from the plurality of laser beam outputting sections. At least one laser beam outputting section emits the laser beam at a different timing from the other laser beam outputting sections, and a beam angle of at least one laser beam outputting section which irradiates the modulation element is different from a beam angle of the other laser beam outputting sections which irradiate the modulation element.

According to the image forming device of the present invention, speckle noise can be removed without any physical movement mechanism. Not mounting any physical movement mechanism can improve reliability as the device.

The image forming device may further include an optical integrator disposed between the plurality of laser beam outputting sections and the modulation element.

The image forming device may arrange the plurality of laser beam outputting sections in a form of array, and may further include an optical refractive element between the plurality of laser beam outputting sections and the optical integrator. The beam angle may be varied depending on the positions of the optical refractive element through which the laser beams emitted from the plurality of laser beam outputting sections pass.

The image forming device may arrange the plurality of laser beam outputting sections in a form of array, and may further include an optical refractive element which varies the beam angle biaxially for each of the plurality of laser beam outputting sections between the plurality of laser beam outputting sections and the optical integrator.

Preferably, the emission time of one pattern when individual laser beam outputting sections or their combinations emit laser beams is 10 msec or less.

More preferably, the continuous emission time of each laser beam outputting section is 1 μsec or less.

The plurality of laser beam outputting sections may emit laser beams in such a manner that sum of laser beams emitted from the plurality of laser beam outputting sections become a quasi-continuous wave and the power of the sum of beams is modulated by an image signal.

The plurality of laser beam outputting sections may emit laser beams in such a manner that sum of laser beams emitted from the plurality of laser beam outputting sections become a quasi-rectangular wave of 100 Hz to 2 kHz and the power of the quasi-rectangular wave is modulated by an image signal.

The image forming device may further include an optical integrator, on side surfaces of which the plurality of laser beam outputting sections are arranged, and which emits laser beams incoming through the side surfaces, from a main surface to the modulation element.

The plurality of laser beam outputting sections may be arranged on the opposite sides of the optical integrator side surfaces, respectively.

The plurality of laser beam outputting sections may be arranged on the four sides of the optical integrator side surfaces, respectively.

The plurality of laser beam outputting sections may be arranged at the point-symmetric position for the central portion of the optical integrator.

The plurality of laser beam outputting sections may be arranged at corners of the optical integrator, respectively.

Each laser beam outputting section may be a laser light source which emits a laser beam.

The light source unit may be further equipped with a laser light source emitting laser beams and fibers, and each laser beam outputting section may be an output portion for emitting the laser beam of the laser light source supplied via the fiber.

### EFFECT OF THE INVENTION

The image forming device of the present invention has a high reliability and can form an image from which speckle noise is removed.

### BRIEF DESCRIPTION OF DRAWINGS

FIG. 1 is a diagrammatic block diagram of an image forming device of embodiment 1 of the present invention;

FIG. 2A and FIG. 2B are an illustration which shows beam angles of laser beams from a light source unit to an optical integrator of embodiment 1 of the present invention, and FIG. 2A is a perspective view and FIG. 2B a front view;

FIG. 3 is an illustration that indicates the radiation timing and power of laser beam outputting sections of embodiment 1 of the present invention;

FIG. 4 is a diagrammatic block diagram of an image forming device of embodiment 2 of the present invention;

FIG. 5 is an illustration which shows beam angles of laser beams from a light source unit to an optical integrator of embodiment 2 of the present invention;

FIG. 6 is an illustration that indicates the radiation timing and power of laser beam outputting sections of embodiment 2 of the present invention;

FIG. 7 is a diagrammatic block diagram of an image forming device of embodiment 3 of the present invention;

FIG. 8 is a diagrammatic block diagram of an image forming device of embodiment 4 of the present invention;

FIG. 9 is a diagrammatic block diagram of an image forming device of embodiment 5 of the present invention; and

FIG. 10 is a diagrammatic block diagram of an image forming device of embodiment 6 of the present invention.

### DESCRIPTION OF REFERENCE NUMERALS

1a, 11a Red light source unit
1b, 11b Green light source unit
1c, 11c Blue light source unit
1a_1 to 1a_3, 11a_1 to 11a_3, 71a_1 to 71a_6 Red laser beam outputting sections
1b_1 to 1b_3, 11b_1 to 11b_3, 71b_1 to 71b_6, 81b_1 to 81b_6,
1b_1 to 101b_4 Green laser beam outputting sections
1c_1 to 1c_3, 11c_1 to 11c_3, 71c_1 to 71c_6 Blue laser beam outputting sections
2 Illuminating optical system
4 Optical integrator
6 Projection optical system
7, 47, 77 Modulation element
8 Projection optical system
9, 49 Dichroic prism
10 Screen
21, 51 Optical refractive element
74 Light guide plate optical integrator
81b_0 Green laser light source
82 Fiber
94 Plate type optical integrator

### BEST MODE FOR CARRYING OUT THE INVENTION

Referring now to appended drawings, embodiments according to the present invention will be described.

### Embodiment 1

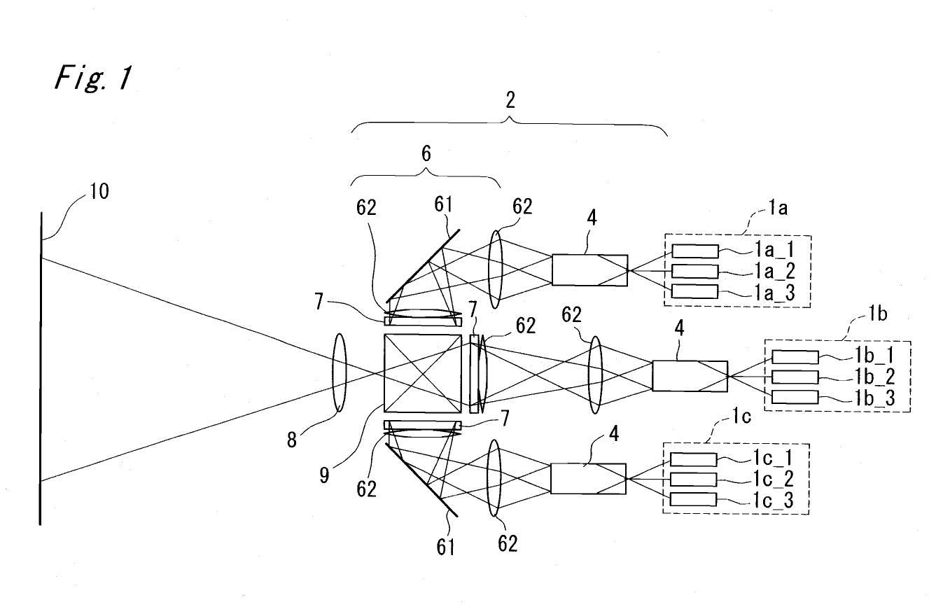

FIG. 1 shows a diagrammatic block diagram of an image forming device of embodiment 1 of the present invention. The image forming device of this embodiment is a projection display using a laser light source.

### [Configuration of the Image Forming Device]

The image forming device of this embodiment includes a red light source unit 1a which emits red laser beams, a green light source unit 1b which emits green laser beams, and a blue light source unit 1c which emits blue laser beams. The red light source unit 1a, green light source unit 1b, and blue light source 1c have laser beam outputting sections 1a_1, 1a_2, 1a_3, laser beam outputting sections 1b_1, 1b_2, 1b_3, and laser beam outputting sections 1c_1, 1c_2, 1c_3, respectively. The laser beam outputting sections 1a_1, 1a_2, 1a_3 are a red laser light source which emits a red laser beam. The laser beam outputting sections 1b_1, 1b_2, 1b_3 are a green laser light source which emits a green laser beam. The laser beam outputting sections 1c_1, 1c_2, 1c_3 are a blue laser light source which emits a blue laser beam.

The image forming device of this embodiment includes an illuminating optical system 2 and modulation element 7 for every light source units 1a through 1c. The laser beams radiated from three-color light source units 1a through 1c of red, green, and blue (RGB) are guided to the illuminating optical system 2 which irradiates the modulation element 7 that modulates each color of RGB, respectively. Each illuminating optical system 2 includes an optical integrator 4 which trims laser beams radiated from light source units 1a through 1c into rectangles and nearly uniformizes and a projection optical system 6 which relays the beam of the optical integrator 4 to the modulation element 7. The projection optical system 6 includes a mirror 61 and a field lens 62.

The image forming device of this embodiment further contains a dichroic prism 9 which combines RGB laser beams radiated from three modulation elements 7 and a projection optical system 8 which enlarges the combined beams and projects them on a screen 10. The image forming device of this embodiment forms a colored image on the screen 10 by spatial additive color mixture.

### [Beam Angle of Laser Beam]

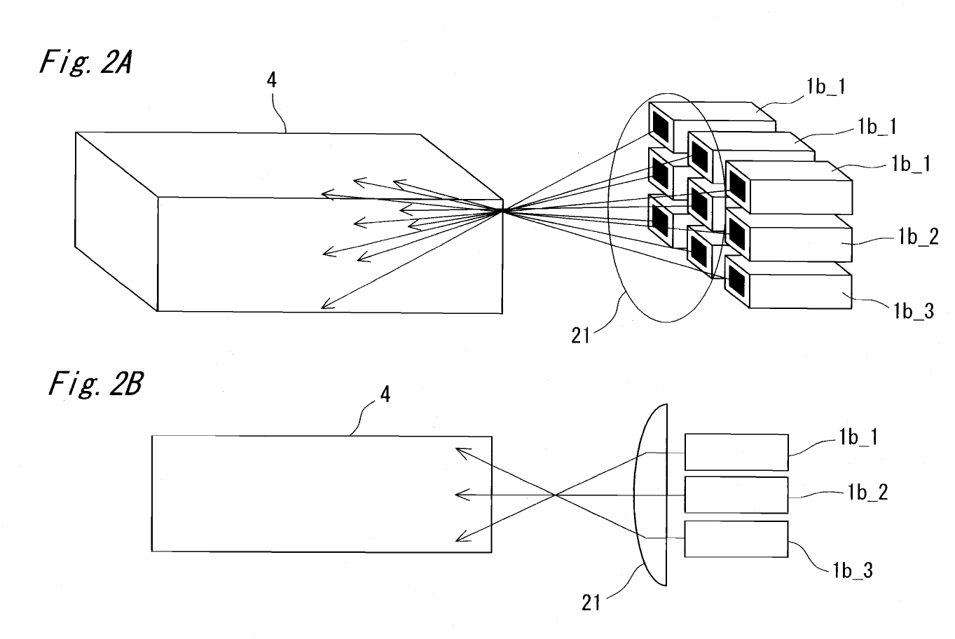

FIGS. 2A and 2B show configuration in which laser beams emitted from the laser beam outputting sections 1b_1, 1b_2 and 1b_3 of the green light source unit 1b enter the optical integrator 4 at varying beam angles. FIG. 2A is a perspective view that shows the laser beam outputting sections 1b_1, 1b_2, and 1b_3 of the green light source unit 1b, optical refractive element 21, and optical integrator 4. FIG. 2B is a front view thereof. As shown in FIGS. 2A and 2B, laser beam outputting sections 1b_1, 1b_2, and 1b_3 are installed 3 units each in the width direction and a total of 9 laser beam outputting sections are arranged in the form of two-dimensional array.

The image forming device of the embodiment includes an optical refractive element 21 between nine laser beam outputting sections and the optical integrator 4. The optical refractive element 21 is an element to vary the beam angle for every laser beam outputting section and specifically, it is a prism array which varies the gradient for each convex lens or laser beam outputting section. The green laser beams radiated from nine laser beam outputting sections, respectively, enter the optical refractive element 21, and are guided to the optical integrator 4 with the beam angles biaxially varied for each laser beam outputting section in accord with the passing positions of the optical refractive element 21. This embodiment controls the beam angle of laser beam radiated from each laser beam outputting section by installing one optical refractive element 21 for 9 laser beam outputting sections. Because the laser beams radiated from a plurality of laser beam outputting sections vary the angles when they enter the illuminating optical system 2, the angle of illuminating the modulation element 7 varies for each laser beam outputting section.

In FIGS. 2A and 2B, description was made on the green light source unit 1b but the red light source unit 1a and blue light source unit 1c have the configuration same as that of the green light source unit 1b, and the laser beams emitted from nine laser beam outputting sections arranged in a form of two-dimensional array are guided, through one optical refractive element 21, to the optical integrator 4, respectively, at biaxially varying beam angles for each laser beam outputting section. With respect to the beam angles of the plurality of laser beam outputting sections, it is not necessary that all angles must be different. It is acceptable that there are multiple sets of same beam angles as far as the laser beam outputting sections are configured to have several varying beam angles.

### [Laser Beam Radiation Timing]

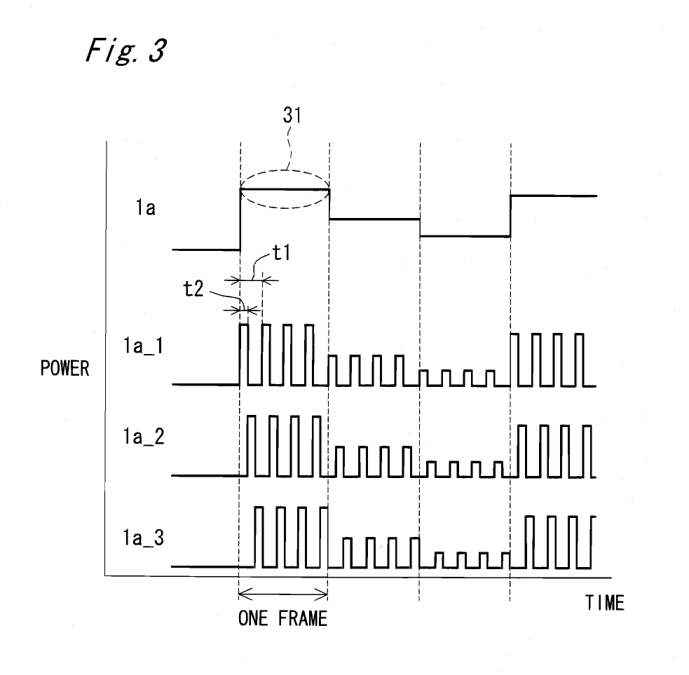

Each of red light source unit 1a, green light source unit 1b and blue light source unit 1c radiates laser beams from each laser beam outputting section in predetermined order. FIG. 3 shows the radiation timing of laser beam by each laser beam outputting section and power modulation by an image signal, with the red light source unit 1a taken for an example. In FIG. 3, each laser beam outputting section continuously radiates laser beams in order of 1a_→1a_2→1a_3→1a_1→ . . . so that sum of beams of each laser beam outputting section of the red light source unit 1a forms the quasi-continuous wave 31. In the event that image signals vary in accord with video pictures such as bright scenes, dark scenes, etc., power of each laser beam outputting section is modulated according to an image signal. In FIG. 3, an example in which an image signal is modulated for each frame is shown and the power of sum of beams of the red laser light source 1a is modulated step-by-step for every frame.

### [Effect]

The image forming device of this embodiment varies the beam angle for each laser beam outputting section in each of the red light source unit 1a, green light source unit 1b and blue light source unit 1c and, each laser beam outputting section emits laser beams in turn with different timing. Because the angle of light that irradiates the modulation element 7 is varied as time passes by this configuration, it is possible to vary the angle at which light is projected on the screen 10. Because by this, the speckle noise is averaged as viewed from viewing audience, the speckle noise can be removed. In this way, this embodiment can remove the speckle noise without installing the physical movement mechanism. Consequently, an image forming device with superb dependability can be achieved. In addition, it has an advantage that the device can be downsized by not installing any mobile component, which is a physical movement mechanism.

In addition, according to this embodiment, the plurality of laser beam outputting sections individually and continuously radiate laser beams in such a manner that the sum of beams of each laser beam outputting section becomes the quasi-continuous wave 31, so that the peak output of each laser beam outputting section can be suppressed even when a bright image is displayed. By this, safety as a device can be improved. Furthermore, it is possible to prevent damage to optical components and laser light source itself caused by laser beams. Still more, it is possible to prevent deterioration due to heat of laser light sources and light resistance of optical components is improved. In addition, it is possible to suppress laser beam outputs in the case of dark images by power-modulating the output of the sum of beams by each frame, and power-saving can be achieved. Still furthermore, synchronizing and controlling the modulation element 7 can increase the number of contrasts and tones.

By the way, in each of the red light source unit 1a, green light source unit 1b, and blue light source unit 1c, it is not necessary for all the laser beam outputting sections to radiate laser beams in order, respectively, but laser beams may be radiated in order by combinations of the plurality of laser beam outputting sections. For example, laser beams may be radiated from each of laser beam outputting section, such as (1a_1+1a_2)→(1a_2+1a_3)→(1a_3+1a_1)→(1a_1+1a_2)→(1a_2+1a_3)→ . . . . Furthermore, laser beam outputting sections to be used or combinations of laser beam outputting sections may be changed as time changes.

In addition, in each of red light source unit 1a, green light source unit 1b, and blue light source unit 1c, the three laser beam outputting sections arranged in the width direction of the laser beam outputting section of FIG. 2 may radiate laser beams simultaneously or may radiate laser beams in order at varying timing, respectively. For example, three laser beam outputting sections 1a_1 may radiate laser beam simultaneously at the timing shown in 1a_1 of FIG. 3 or radiate laser beams in turn at different timing, respectively. Furthermore, the order of radiating laser beams should not be limited to FIG. 3. The sum of beams of each laser beam outputting section has only to form the quasi-continuous wave 31.

In FIG. 3, the time t1 of one cycle from when each laser beam outputting section radiates laser beams to when it next radiates laser beams is preferably 10 msec or less. It is still more preferable that the radiation time t2 when the laser beam outputting section independently or a combinations thereof (for example, laser beam outputting sections 1a_1 and 1a_2) radiate one pattern of laser beams is 10 msec or less. By keeping the one-pattern output time t2 to 10 msec or less, multiple speckle noise patterns can be generated within the time when the viewing audience is cognizant of one image, and the speckle noise can be removed. In addition, when multiple pattern radiations are repeated in one frame, it is not necessary to keep the 1-cycle time to be 10 msec or less for all the patterns. It is only required to generate multiple speckle noise patterns, and for example, in the event that 15 patterns are radiated in one frame, the radiation time for 10 patterns may be brought to 10 msec or less.

It is more preferable that the time when each laser beam outputting section continuously radiates laser beams is 1 μsec or less. Keeping the continuous radiation time of each laser beam radiation unit to 1 μsec or less can increase the peak power by pulse-radiation of laser beams and can increase the image brightness. In addition, in the case of same image brightness, the number of laser beam outputting sections can be reduced, and size reduction and cost reduction can be achieved. Keeping the continuous radiation time from one laser beam outputting section to 1 μsec or less can simultaneously achieve speckle noise reduction effects by lowering the coherency of laser beams. When the continuous radiation time of each laser beam outputting section is shortened, the number of radiation patterns to be repeated in the frame may be increased.

The output power of each laser beam outputting section may not have to be the same but the power per one frame of sum of beams should be controlled to be the amount modulated by an image signal. In FIG. 3, description was made on the case in which the sum of beams are modulated stepwise by the image signal, but they may not be modulated stepwise and the modulated shape of sum of beams may have any waveform if the sum of light volume per one frame is a controlled volume.

It is preferable to provide time to radiate beams slightly simultaneously in order to prevent any gap formed when laser beams are continuously radiated and make the quasi-continuous wave 31. In addition, even when any slight gap time is generated due to delay of electrical signals when continuous radiation is carried out to have the quasi-continuous wave 31, such case will be regarded as the quasi-continuous wave in the present invention. In addition, when frames are changed over, it may be controlled to form the radiation gap time by synchronizing the radiation with the modulation element 7.

It is not necessary that the center wavelength of laser beam radiated from the plurality of laser beam outputting sections, respectively, may be identical. It is preferable to shift the center wavelength in the range where the color displayed as the monochromatic laser light source can be faithfully reproduced and to expand the total spectral width as the monochromatic laser light source. By expanding the spectral width, coherency can be lowered and speckle noise is able to be further reduced. For the total spectral width, the full width at half maximum Δλ is preferably between 5 and 10 nm.

As is the case of this embodiment, it is preferable that the beams radiated from the plurality of laser beams output units should irradiate the same modulation element 7 via the same optical integrator 4, in each of the red, green, and blue monochromatic light source units 1a, 1b, and 1c, respectively. In the event that the plurality of laser beam outputting sections are used, uniform illumination becomes difficult due to deviation of each light intensity distribution or light axis, but illuminating the modulation element 7 using the same optical integrator 4 averages the light intensity, and it becomes possible to easily irradiate the modulation element 7 uniformly. As is the case of this embodiment, even when one optical integrator 4 is used for each of light source units 1a, 1b, and 1c, since the plurality of laser beam outputting sections radiate laser beams in turn, the light of sequential varying wave surfaces (angles) is radiated from the optical integrator 4, and the angle to irradiate the modulation element 7 is changed.

In this embodiment, the laser beam outputting sections provided in red, green, and blue light source units 1a, 1b, and 1c are monochromatic laser light sources which emits a laser beam, but each laser beam outputting section may be an output portion for outputting a laser beam. That is, in each of the red, green, and blue light source units 1a, 1b, and 1c, each light source unit contains one monochromatic laser light source which emits any of laser beams of red, green, and blue, and the laser beams from monochromatic laser light sources are emitted from the plurality of laser beam outputting sections at varying timing as in the case of this embodiment. In case that the laser beam outputting section is an output portion, this embodiment can be applied.

### Embodiment 2

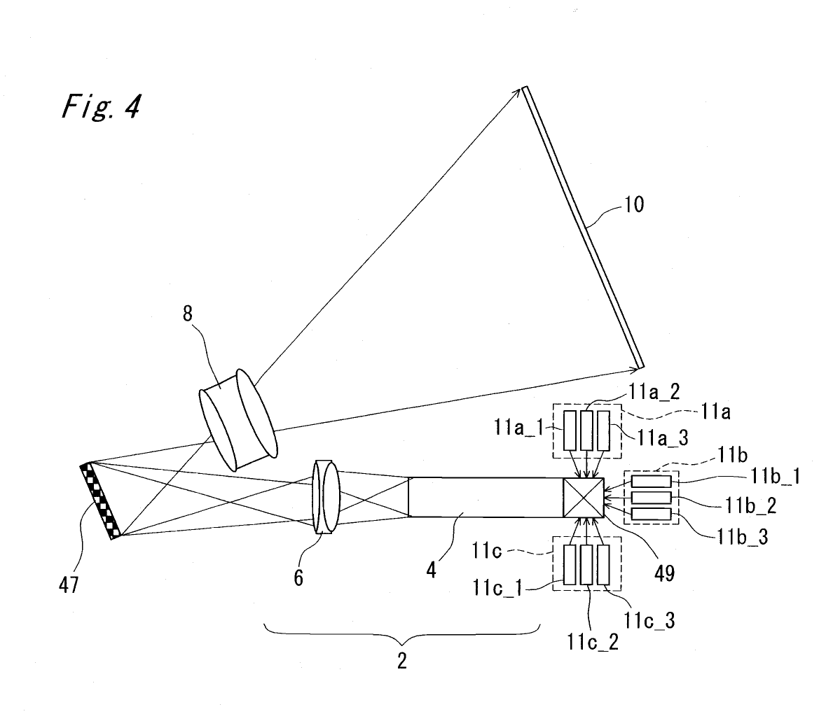

FIG. 4 shows a diagrammatic block diagram of an image forming device of embodiment 2 of the present invention. The image forming device according to this embodiment is a projection display and has a configuration that laser beams emitted from a red light source unit 11a, green light source unit 11b and blue light source unit 11c enter the same modulation element 47 via the same optical integrator 4. The light source units of RGB three colors 11a, 11b, and 11c use the same modulation element 47 by time-sharing. Other configurations and operations are nearly same as those of embodiment 1. Now the detail will be explained with respect to the configuration of the image forming device of this embodiment.

### [Configuration of the Image Forming Device]

The image forming device of this embodiment includes the red light source unit 11a, green light source unit 11b, and blue light source unit 11c, which include the plurality of laser beam outputting sections, respectively, as is the case of embodiment 1. The laser beam outputting sections 11a_1, 11a_2, and 11a_3 of the red light source unit 11a are red laser light sources which emit red laser beams. The laser beam outputting sections 11b_1, 11b_2, and 11b_3 of the green light source unit 11b are green laser light sources which emit green laser beams. The laser beam outputting sections 11c_1, 11c_2, and 11c_3 of the blue light source unit 11c are blue laser light sources which emit blue laser beams.

The image forming device of this embodiment further contains the illuminating optical system 2 and a modulation element 47 common to RGB light source units 11a through 11c. The beam radiated from the laser light sources 11a through 11c of three RGB colors are guided to the same modulation element 47 via the same illuminating optical system 2. The illuminating optical system 2 includes a dichroic prism 49 for adjusting nearly coaxially laser beams of each color, optical integrator 4, and projection optical system 6. In order to focus the three-color laser beams nearly coaxially, the dichroic prism 49 is used, but a dichroic mirror or a polarizing mirror may be used. By the way, they may not be focused particularly coaxially if multiple-color laser beams can irradiate a single modulation element 47.

The modulation element 47 is specifically a two-dimensional micro-mirror device. The laser light sources of three RGB colors 11a, 11b, and 11c use the single modulation element 47 by time-sharing and displays color images on a screen by time-averaged additive color mixing.

### [Beam Angle of Laser Beams]

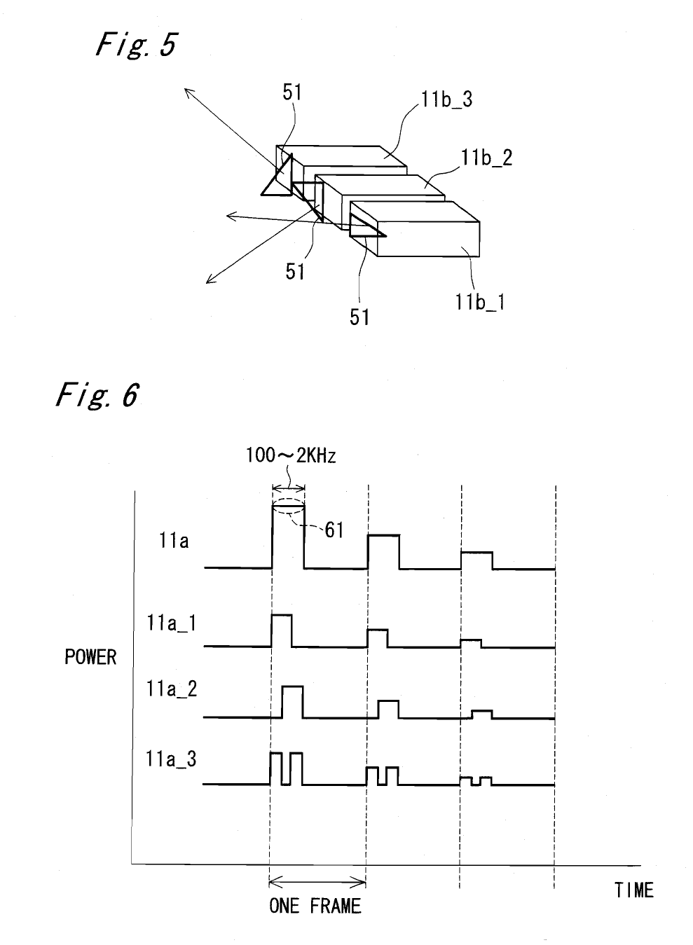

Multiple laser beams radiated from each laser beam outputting section of red light source unit 11a, green light source unit 11b, and blue light source unit 11c are guided into the dichroic prism 49 at varying beam angles. FIG. 5 shows laser beam outputting sections 11b_1, 11b_2, and 11b_3 and three optical refractive elements 51 arranged with the directions varied for each laser beam outputting section, with the green light source unit 11b taken as an example. As shown in FIG. 5, laser beam outputting sections 11b_1, 11b_2, and 11b_3 are arranged in a form of one-dimensional array. The laser beams radiated from laser beam outputting sections 11b_1, 11b_2, and 11b_3 enter the dichroic prism 49 at biaxial varying beam angles (two axes of x-axis and y-axis with respect to the optical axis z) by optical refractive elements 51 equipped on the output side. Same as the green light source unit 11b, the red light source unit 11a and the blue light source unit 11c are equipped with optical refractive elements 51.

### [Laser Beam Radiation Timing]

Because each laser beam outputting section of the red light source 11a, green light source unit 11b, and blue light source unit 11c time-shares and uses a single modulation element 71, each laser beam outputting section emits laser beams in turn so that the sum of beams of each color form quasi-rectangular wave in the divided time.

FIG. 6 shows power modulation based on the radiation timing of laser beam outputting sections 11a_1, 11a_2, and 11a_3 and an image signal, with the red light source unit 11a taken for an example. FIG. 6 is an example to radiate laser beams in turn by combinations of the plurality of laser beam outputting sections, and radiates laser beams in order of (11a_1+11a_3)→(11a_1+11a_2)→(11a_2+11a_3)→(11a_1+11a_3)→ . . . . Laser beam outputting sections 11a_1, 11a_2, and 11a_3 radiate laser beams with such radiation timing that the sum of beams of red light source unit 11a forms the quasi-rectangular wave 61. In this embodiment, because the single modulation element 47 is used by time-sharing by RGB three colors, the pulse width of the quasi-rectangular wave 61 of the red light source unit 11a, green light source unit 11b, and blue light source unit 11c is controlled within the range from 100 Hz to 2 kHz, respectively. In this embodiment, each quasi-rectangular wave 61 of red, green, and blue is in turn radiated to the modulated element 47 in one frame. Keeping the pulse width of the quasi-rectangular wave 61 to 100 Hz to 2 kHz enables to give tone by the modulation element 47 without color breakup, etc.

FIG. 6 shows how each laser beam outputting section modulates the output power in such a manner that the quasi-rectangular wave 61 of the sum of beams is modulated step-by-step for each frame by an image signal. Since each laser beam outputting section modulates power by an image signal, electric power saving can be achieved in the case of dark images. In addition, by controlling the power of each laser beam outputting section in synchronism with the modulation element 7, the image contrasts and the number of tones can be increased.

### [Effects]

This embodiment has the effects same as those of embodiment 1. That is, in each light source unit, the optical refractive element 51 is equipped to every one of the laser beam outputting section to vary the angle of illuminating the modulation element 47 on two axes for each laser beam outputting section, and combinations of the plurality of laser beam outputting sections radiate laser beams in turn, and the number of speckle noise patterns are thereby increased. By this, speckle noise after time-averaging can be reduced.

Because in the image forming device of this embodiment, red, green, and blue light source units 11a, 11b, and 11c share the optical integrator 4 and the modulation element 47, and each laser beam outputting section of red, green, and blue light source units 11a, 11b, and 11c irradiate the same modulation element 47 via the same optical integrator 4, the image forming device of this embodiment further provides an effect of downsizing the optical system of the image forming device.

In this embodiment, the laser beam outputting section of each light source unit should not be limited to a single-color laser light source but may be an output portion from which laser beam supplied from one single-color laser light source is outputted.

The configuration to vary the light beam angle of the laser beam outputting section should not be limited to FIG. 2 and FIG. 5. It is only required to have a configuration in which laser beams radiated from each laser beam outputting section enter the optical integrator 4 at biaxial varying beam angles. For example, the plurality of laser beam outputting sections are arranged one-dimensionally while being tilted in different directions and laser beams may enter the dichroic prism 49 via the optical refractive element 21 of FIG. 2.

In FIG. 6, the total beam of each color of red, green and blue forms one quasi-rectangular wave 61 in one frame but the radiation timing of laser beam outputting sections may be controlled to form two or more quasi-rectangular waves 61 in one frame by the total beam of each color. In addition, one pattern total beam is formed by combination of two laser beam outputting sections, but as is the case of embodiment 1, the plurality of laser beam outputting sections may radiate laser beams independently in turn.

In addition, the number of repetitions of a radiation pattern when one quasi-rectangular wave 61 is formed may be increased and the continuous radiation time of each laser beam outputting sections may be shortened. Same as embodiment 1, shortening the continuous radiation time of each laser beam outputting section can increase the peak power by pulse radiation of laser beams and the image brightness can be increased. In addition, in the case of same image brightness, the number of laser beam outputting sections can be reduced, and downsizing and cost reduction can be achieved. Furthermore, by shortening the continuous radiation time of one laser beam outputting section, speckle noise reduction effects achieved by lowering coherency of laser beams can be simultaneously achieved.

The gap of the radiation time by the laser beam outputting section when the quasi-rectangular wave 61 is formed is preferably 1 μsec or less. When fluctuations of intensity in the quasi-rectangular wave is large in terms of time, it becomes a problem that the image tone is unable to be faithfully reproduced, but by setting the gap of the radiation time to 1 μsec or less, the image tone can be faithfully reproduced.

The output power of each laser beam outputting section may not necessarily be same but it is only required to control the power of total light quasi-rectangular wave 61 to become the power controlled by an image signal.

In embodiment 1 and embodiment 2, the projection optical system 8, which projects images of modulation elements 7 and 47, and the screen 10 are not particularly limited to the embodiments and should only be required to enable viewing audience to observe the modulation element images. For example, the screen 10 may be a front projection type of a reflective type, or may be of a rear projection type of a transmission type. In addition, the projection optical system 8 may not be provided and a transmission type screen may be installed right after the modulation elements 7 and 47.

The illuminating optical system 2 is not limited to embodiments 1 and 2 but should only be required to have a configuration to guide the beam from the laser beam outputting section to modulation elements 7 and 47. The optical integrator 4 should only be required to shape beams and make them nearly uniform, and a fry-eye lens, hologram element, etc. may be used. Furthermore, the projection optical system 6 which relays the light of the optical integrator 4 can be omitted by design.

### Embodiment 3

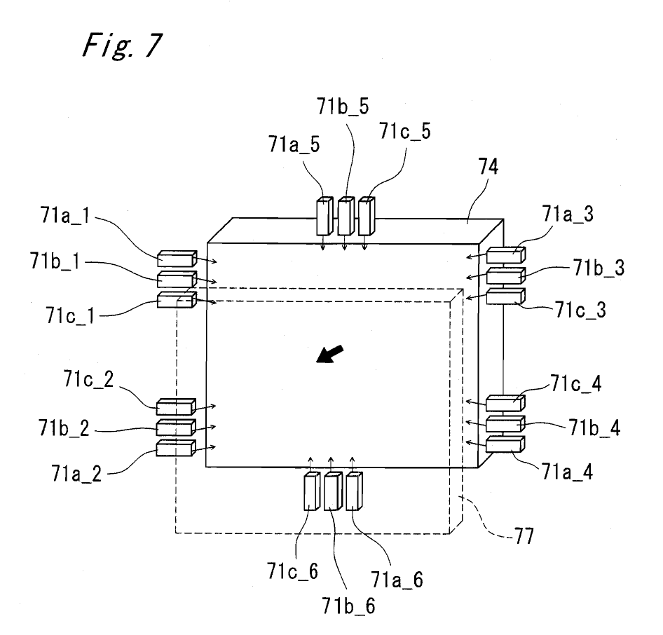

FIG. 7 shows a diagrammatic block diagram of an image forming device of embodiment 3 according to the present invention. The image forming device of this embodiment is a liquid crystal display. A laser light source is used for the backlight of the liquid crystal display. The image forming device of this embodiment contains laser beam outputting sections 71a_1 through 71a_6, which are red laser light sources, laser beam outputting sections 71b_1 through 71b_6, which are green laser light sources, laser beam outputting sections 71c_1 through 71c_6, which are blue laser light sources. The image forming device of this embodiment further contains a light guide plate optical integrator 74, the side surface of which beams of each laser beam outputting section enter and which radiates the beams from the main surface, and a modulation element 77 installed on the main surface side of the light guide plate optical integrator 74 which radiates the beams. The light guide plate optical integrator 74 and the modulation element 77 form an illuminating optical system.

The laser beam outputting sections 71a_1 through 71a_6 which are red laser light sources are arranged on the side surface of the light guide plate optical integrator 74 in such a manner that the laser beam enters the light guide plate optical integrator 74 at varying angles for each laser beam outputting section. This same principle applies to the green and blue laser light sources, too. In this embodiment, on all the four side surfaces of the light guide plate optical integrator 74, respective RGB laser beam outputting sections are located. In FIG. 7, on the top side surface and the bottom side surface of the light guide plate optical integrator 74, one set each of RGB laser beam outputting section is installed, respectively, and on the right and left side surfaces, two sets each of RGB laser beam outputting sections are installed, respectively. By configuring the device in such a manner that the laser beam enter the light guide plate optical integrator 74 at varying angles for each laser beam outputting section, the beam angle when the light guide plate optical integrator 74 irradiates the modulation element 77 is varied for each laser beam outputting section.

Each of RGB laser beam outputting sections radiate laser beams in turn and irradiate the modulation element 77 independently or in combinations as is the case of embodiment 1 or embodiment 2.

The light guide plate optical integrator 74 has a reflection surface on the side surfaces except the rear surface and the portions to which each laser beam outputting section is installed. The light guide plate optical integrator 74 has a homogeneous diffusion means inside and radiates the beam with light amount distribution homogenized from the main surface. The beam radiated from the light guide plate optical integrator 74 is guided to the modulation element 77 and images are formed.

This embodiment has the effects same as those of embodiment 1. That is, since each RGB laser beam outputting section varies the angles for illuminating the modulation element 77 as time passes, speckle noise is removed. The viewing audience who watches the images formed by the modulation element 77 can watch the images without speckle noise. Furthermore, since no physical movement mechanism is installed, the reliability is improved.

Furthermore, according to the configuration of this embodiment, the plurality of laser beam outputting sections can be dispersed and located, this embodiment further provides the effect of increasing the degree of freedom in designing the heat radiation mechanism of the laser beam outputting section.

In addition, since the laser light source is a point source, a problem of difficulty to homogenize the lighting with one laser light source occurs, but as is the case of this embodiment, by having a configuration in which the light enter the light guide plate optical integrator 74 from the plurality of laser beam outputting sections, the degree of homogenization of lighting can be improved as compared to the case of the light which enter the integrator from one point.

In this embodiment, the laser beam outputting section is installed on the side surface of the light guide plate optical integrator 74 but it is only required to vary the angle of illuminating the modulation element 77, and for example, the laser beam outputting sections may be arranged on the rear surface side. In addition, the laser beam outputting sections may be arranged at any place if the angle of the light radiated from the light guide plate optical integrator to irradiate the modulation element 77 varies in accord with laser beam outputting sections.

Laser beam outputting sections of each of RGB colors are not be limited to monochromatic laser light sources but may be output portions from which a laser beam supplied from one monochromatic laser light source is outputted.

### Embodiment 4

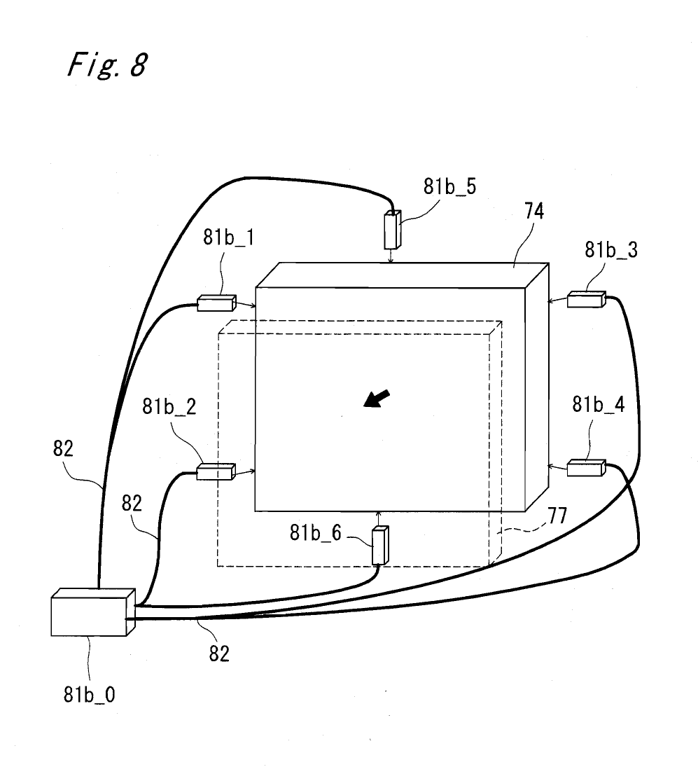

FIG. 8 shows the configuration of the image forming device of embodiment 4 of the present invention. The laser beam outputting sections 81b_1 through 81b_6 shown in FIG. 8 are output portions for emitting a laser beam. The image forming device of this embodiment divaricates the laser beams radiated from the green laser light source 81b_0, couples them with fibers 82, and emits laser beams from the laser beam outputting sections 81b_1 through 81b_6. The green laser light source 81b_0, fibers 82, and laser beam outputting sections 81b_1 through 81b_6 form a green light source unit.

The image forming device of this embodiment is configured to use the laser light source as the backlight of the liquid crystal display, and the light guide plate optical integrator 74 and the modulation element 77 are same as those of embodiment 3. The light guide plate optical integrator 74 is configured by a diffusion structure, prism group, etc., and uniformly irradiates the modulation element 77.

The laser beam outputting sections 81b_1 through 81b_6 are mounted to different places with respect to the light guide plate optical integrator 74 in order to irradiate the modulation element 77 from varying angles. In FIG. 8, same as embodiment 3, laser beam outputting sections 81b_1 through 81b_6 are located on four sides of the side surfaces of the light guide plate optical integrator 74.

The laser beam outputting sections 81b_1 through 81b_6 emit laser beams in turn. For the laser beam radiating pattern, the laser beam outputting sections may emit laser beams independently in turns as is the case of embodiment 1 or combinations of the plurality of laser beam outputting sections may emit laser beams in turn as is the case of embodiment 2. In addition, the laser beam outputting sections used together with time change or combinations of laser beam outputting sections may be varied and emit laser beams in turn.

Even in the case of this embodiment where only one laser light source is used, speckle noise can be removed as is the case of embodiment 7 by successively radiating laser beams from each laser beam outputting section within the time when viewing audience recognizes the brightness.

In addition, even in the case of one laser light source, by radiating beams from the plurality of laser beam outputting sections, beams radiated from the light guide plate optical integrator 74 can be made uniform. That is, the degree of homogeneity of lighting can be improved.

It is possible to prevent damage to optical components and laser light sources caused by laser beam by installing the plurality of laser beam outputting sections and lowering the beam power density of laser beams entering the light guide plate optical integrator 74 from the laser beam inputting sections.

In FIG. 8, description is made on the case in which the green laser light source 81b_0 is used, but for red laser light sources and blue laser light sources, the configuration same as that in FIG. 8 may be used. In each of RGB, by installing multiple output portions to the side surface of the light guide plate optical integrator 74 for one laser light source, each output portion of RGB can be put closer mutually than in FIG. 7 where laser light sources themselves are arranged on the side surface of the light guide plate optical integrator 74. This is suited for a configuration that outputs white color.

Furthermore, the configuration of FIG. 7 and the configuration of FIG. 8 may be combined to configure RGB optical light sources, respectively. For example, with respect to the red and blue laser light sources, using the semiconductor laser, the laser beam outputting sections which are laser light sources may be arranged on the side surface of the light guide plate optical integrator 74 as shown in FIG. 7, whereas for the green laser light source, using fiber laser, the laser beam outputting sections which are output portions may be installed on the side surfaces of the light guide plate optical integrator 74 as shown in FIG. 8. Because it is difficult to emit green laser beams by semiconductor lasers, for the green laser light source, fiber laser which emits green laser beams by wavelength conversion is considered to be used. This embodiment is suited for the case in which fiber laser is used as laser light sources.

### Embodiment 5

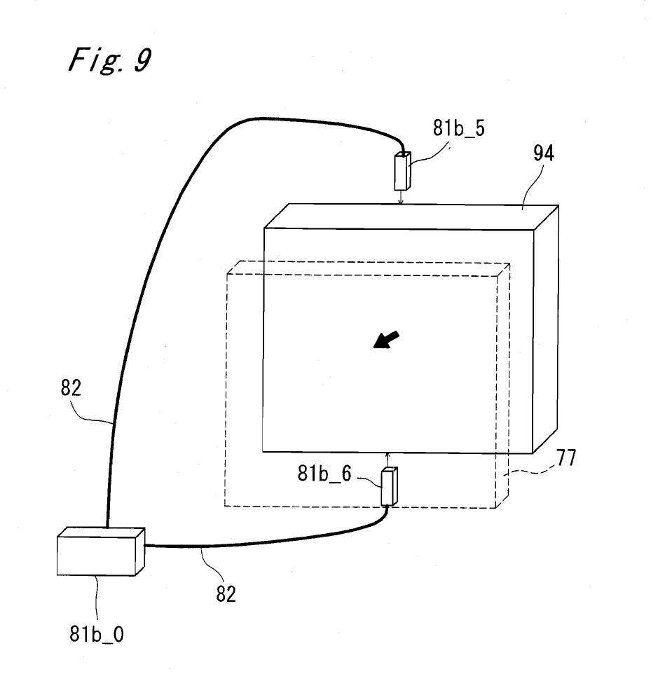

FIG. 9 shows the configuration of the image forming device of embodiment 5. The image forming device of this embodiment includes a plate type optical integrator 94, and on the two sides which are opposite sides of the side surface of the plate type optical integrator 94, laser beam outputting sections 81b_5 and 81b_6 are installed. Other configuration except for this is same as that of embodiment 4.

The plate type optical integrator 94 is a light guide plate type or hollow type optical integrator. In general, when the light enters the plate type optical integrator 94 from one side, light nonhomogeneity is likely to occur between the upstream part of the beam incidence and the downstream part. In particular, in the plate type optical integrator 94 which radiates, to the front, the beam entering from the side surface, a problem occurs in that it becomes difficult to achieve beam homogeneity because the laser light source is a point light source. However, as is the case of this embodiment, by installing laser beam outputting sections 81b_5 and 81b_6 on the opposite sides, the upstream part and the downstream pare of beam incidence are able to be eliminated, and furthermore, the laser beam outputting sections 81b_5 and 81b_6 emit laser beams alternately within the time at which viewing audience recognizes the image, for example, 10 msec or lower, and homogeneous lighting can be achieved.

Because it is at 180 degrees that the greatest change is made in the beam incidence angle to reduce speckle noise, it is preferable to arrange a pair of laser beam outputting sections on the opposite sides. It is recommended to arrange the laser beam outputting sections mutually on the opposite side of the side surface of the plate type optical integrator 94 so that they are located at the point-symmetric position to the center part of the plate type optical integrator 94. It is preferable to adjust the output angle of laser beams in such a manner that the main beams oppositely travel to the center part of the plate type optical integrator 94 from the viewpoint of removing speckle noise.

According to this embodiment, reduction of speckle noise and homogeneous lighting can be achieved. In order to achieve reduction of speckle noise and homogeneous lighting, it is recommended to install at least one set of laser beam outputting sections to the opposite sides of the side surface of the plate type optical integrator 94. In order to still increase speckle noise reduction and to achieve still more homogeneous lighting, it is preferable to arrange multiple sets of laser beam outputting sections on the opposite sides of the plate type optical integrator 94 or at the position point-symmetrical to the center part of the plate type optical integrator 94.

### Embodiment 6

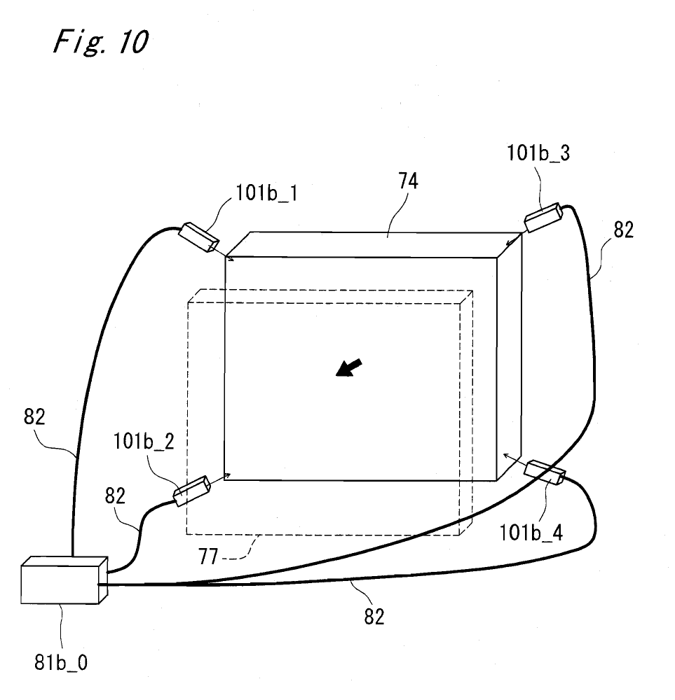

FIG. 10 shows a configuration of the image forming device of embodiment 6. The image forming device of this embodiment has laser beam outputting sections 101b_1 through 101b_4 arranged at the corner of the light guide plate optical integrator 74. The laser beam outputting sections 101b_1 through 101b_4 are arranged in such a manner that each laser beam outputting section faces each other, that is, the main light beams are directed to the center part of the plate type optical integrator 74. In this embodiment, the configuration and operation except for the arrangement of laser beam outputting sections 101b_1 through 101b_4 are same as those of embodiment 4.

In case that laser light source which is point light source is used, the beam is difficult to reach the corner of the light guide plate optical integrator 74, and homogenization is difficult, but as is the case of this embodiment, by installing laser beam outputting sections 101b_1 through 101b_4 at the corner, homogenization can be easily achieved.

To the radiating side of the laser beam outputting sections 101b_1 through 101b_4, it is preferable to install optical elements including a cylindrical lens that expands laser beams in the plane direction or lenticular lens with cylindrical lens continued. By making the laser beams to the planar state by the optical element, homogenization can be supported.

With respect to embodiment 1 to embodiment 6, the number of laser beam outputting sections is not limited to any of the embodiments. Two or more laser beam outputting sections may be provided in each light source unit of RGB so that laser beams can be radiated in turns.

In addition, in embodiment 1 through embodiment 6, each of red, green, and blue light source units has the plurality of laser beam outputting sections, but the plurality of laser beam outputting sections may be provided for any one of red, green, and blue.

Furthermore, with respect to the image forming device from embodiment 1 through embodiment 6, three-color laser light sources of RGB are used, but the present invention is not be particularly limited to this, but laser light sources of three colors or more may be used.

### INDUSTRIAL APPLICABILITY

The image forming device according to the present invention has a high reliability and can form an image from which speckle noise is removed, and is useful for a projection display and a liquid crystal display which form motion picture, still images, and the like.

1. An image forming device, comprising:
a light source unit that emits laser beams by a plurality of laser beam outputting sections; and
a modulation element that is irradiated with the laser beams emitted from the plurality of laser beam outputting sections,
wherein at least one laser beam outputting section emits the laser beam at a different timing from the other laser beam outputting sections, and
a beam angle of at least one laser beam outputting section which irradiates the modulation element is different from a beam angle of the other laser beam outputting sections which irradiate the modulation element.

2. The image forming device according to claim 1, further comprising an optical integrator disposed between the plurality of laser beam outputting sections and the modulation element.

3. The image forming device according to claim 2, wherein the plurality of laser beam outputting sections are arranged in a form of array,
an optical refractive element is further provided between the plurality of laser beam outputting sections and the optical integrator, and
the beam angle is varied depending on the positions of the optical refractive element through which the laser beams emitted from the plurality of laser beam outputting sections pass.

4. The image forming device according to claim 2, wherein the plurality of laser beam outputting sections are arranged in a form of array, and
an optical refractive element is provided between the plurality of laser beam outputting sections and the optical integrator, the optical refractive element varying the beam angle biaxially for each of the plurality of laser beam outputting sections.

5. The image forming device according to claim 1,
wherein the emission time of one pattern when individual laser beam outputting sections or their combinations emit laser beams is 10 msec or less.

6. The image forming device according to claim 1, wherein the continuous emission time of each laser beam outputting section is 1 μsec or less.

7. The image forming device according to claim 1, wherein the plurality of laser beam outputting sections emit laser beams in such a manner that sum of laser beams emitted from the plurality of laser beam outputting sections become a quasi-continuous wave and the power of the sum of beams is modulated by an image signal.

8. The image forming device according to claim 1, wherein the plurality of laser beam outputting sections emit laser beams in such a manner that sum of laser beams emitted from the plurality of laser beam outputting sections become a quasi-rectangular wave of 100 Hz to 2 kHz and the power of the quasi-rectangular wave is modulated by an image signal.

9. The image forming device according to claim 1, further comprising an optical integrator, on side surfaces of which the plurality of laser beam outputting sections are arranged, and which emits laser beams incoming through the side surfaces, from a main surface to the modulation element.

10. The image forming device according to claim 9, wherein the plurality of laser beam outputting sections are arranged on the opposite sides of the optical integrator side surfaces, respectively.

11. The image forming device according to claim 9, wherein the plurality of laser beam outputting sections are arranged on the four sides of the optical integrator side surfaces, respectively.

12. The image forming device according to claim 9, wherein the plurality of laser beam outputting sections are arranged at the point-symmetric position for the central portion of the optical integrator.

13. The image forming device according to claim 12, wherein the plurality of laser beam outputting sections are arranged at corners of the optical integrator, respectively.

14. The image forming device according to claim 1, wherein each laser beam outputting section is a laser light source that emits a laser beam.

15. The image forming device according to claim 1, wherein the light source unit further includes a laser light source emitting laser beams and fibers, and
each laser beam outputting section is an output portion for emitting the laser beam of the laser light source supplied via the fiber.
